(19) United States
(12) Patent Application Publication
(10) Pub. No.: US 2009/0170213 A1
(43) Pub. Date: Jul. 2, 2009

(54) High-Throughput Screening of Enantiomeric Excess (EE)

(75) Inventors: Nathan Jones, London (CA); Silvia Mittler, London (CA); Mohammad Nuruzzaman, London (CA); Thomas Preston, Mississauga (CA)

Correspondence Address: Ralph A. Dowell of DOWELL & DOWELL P.C., 2111 Eisenhower Ave, Suite 406, Alexandria, VA, 22314, US

(73) Assignee: University of Western Ontario, LONDON, ON (CA)

(21) Appl. No.: 12/227,649

(22) PCT Filed: May 23, 2007
(86) PCT No.: PCT/CA2007/000896

§ 371 Date: Feb. 11, 2009

Related U.S. Application Data
(60) Provisional application No. 60/802,523, filed on May 23, 2006.

(51) Int. Cl. G01N 21/78

(52) U.S. Cl. 436/164

(57) ABSTRACT

The present invention provides a method for high-throughput screening of enantiomeric excess (ee), comprising synthesizing a sensor made from an aggregate of gold nanoparticles whose surfaces have been elaborated with a chiral “host” that includes two optically pure binaphthol groups linked together by a diethanolamine bridge that is tethered via nitrogen to its associated gold nanoparticle, and in which aggregate the individual particles are held together by a bridging chiral “di-guest,” which contains an amino acid functionality at both ends and which interacts with the surface-bound hosts through hydrogen bonds. To screen, one adds a chiral analyte, which may be the product of an asymmetric catalytic reaction, or some other chiral species, in the form of a scalemic solution to a solution containing the aforemeritioned aggregate wherein one enantiomer of the analyte competes effectively with the “di-guest” for the “host,” while the other does not, and wherein a diastereoselective dispersion of the aggregate occurs, which brings about a large shift in the naked-eye-visible plasmon resonance absorption band of the gold nanoparticles, from a long wavelength for the aggregated nanoparticles to a shorter wavelength for the dispersed particles, and wherein the extent of the colour change is indicative of the degree to which the aggregate is dispersed and provides a rapid and effective measure of the ee of the chiral analyte.

### CROSS REFERENCE TO RELATED U.S. APPLICATIONS

This patent application relates to, and claims the priority benefit from, U.S. Provisional Patent Application Ser. No. 60/802,523 filed on May 23, 2006, in English, entitled HIGH-THROUGHPUT SCREENING OF ENANTIOMERIC EXCESS (EE), and which is incorporated herein by reference in its entirety.

### FIELD OF THE INVENTION

The present invention relates to a method for high-throughput screening of enantiomeric excess (ee).

### BACKGROUND OF THE INVENTION

In much the same way that a person's hands are mirror images of one another, many molecules are also “handed,” or chiral. A chiral molecule is one that cannot be superimposed on its mirror image. The primary reason that chiral molecules are important is that they constitute the fundamental building blocks of much of biology: DNA, proteins and sugars are all chiral. Therefore, many biologically important interactions, such as those between a drug and its specific target in the body, depend upon recognition events between two chiral components. These interactions are often exquisitely selective so that only one “hand,” or enantiomer, of a chiral molecule is recognised, while the other is rejected, in the same way that a right-handed glove will fit only the right hand. The importance of these discriminating, or enantioselective, chiral-chiral interactions is underscored by the fact that nine of the top ten selling drugs, whose global sales exceeded US $53 billion in 2004, have chiral active ingredients; of these, five are delivered as single enantiomers.

Single enantiomers of small molecules are accessible by four routes: (1) synthesis from the currently-available chiral pool; (2) resolution, principally by crystallisation of diastereomeric salts and by chiral chromatography; (3) biological (enzymatic) asymmetric catalysis, or “biocatalysis;” and (4) chemical asymmetric catalysis. The first two methods enjoy wide currency in the pharmaceutical industry, and are predicted to remain the dominant routes to enantiopure compounds until the end of this decade. In order for biological and chemical methods to gain momentum, the traditional serial development and testing of catalysts (and biocatalysts) for asymmetric transformations, which is laborious and time-consuming, must be usurped by quicker, less demanding means. In order to facilitate this, two core technologies are being developed: combinatorial synthesis and high-throughput ee-screening (ee=enantiomeric excess, or, the percentage by which one enantiomer exceeds the other in a scalemic mixture.)

Combinatorial synthesis of biocatalysts is synonymous with mutagenesis. In the development of homogeneous inorganic (metal-based) catalysts, combinatorial synthesis depends on the development of large libraries of ligands by modular means. Both of these areas are undergoing rapid development and will not be discussed further in this patent.

High-throughput ee-screening on the other hand is the stumbling block to rapid discovery of (bio)catalysts for asymmetric transformations. Even as recently as 1997, not a single high-throughput, ee-screening system existed, although significant progress in achiral screening methods had been made since the middle of that decade. The “classical” methods for ee determination are the following: (1) covalent attachment of enantiopure derivitising agents followed by measurement of diastereomeric excess (de), typically by NMR spectroscopy; (2) detection of transient, non-covalent interactions between the target molecule and a chiral-shift reagent, also by NMR spectroscopy, or through use of chiral solvents; and (3) the use of chiral stationary phases in gas and high performance liquid chromatography (GC and HPLC.). Direct detection of ee by optical rotation and/or circular dichroism (CD) is possible, of course, but typically is hampered by relatively low sensitivity and a low tolerance for impurities, particularly chiral ones.

In addition to these traditional approaches, some intriguing advances have been made recently using other techniques. These can be broken down into the following categories: (1) mass spectrometric determination; (2) “next generation” chromatographic determination, including by capillary electrophoresis (CE); (3) UV-visible spectroscopic determination; and (4) fluorescence determination. In addition, there have been some reports describing even more creative, less practical, approaches, including the use of molecularly imprinted polymers. The current state of the art has been outlined in recent reviews by Reetz, Tsukamoto and Kagan, and Finn.

In summary, there is a pervasive need that for a method for high-throughput screening of enantiomeric excess (ee).

### SUMMARY OF THE INVENTION

The present invention provides a method for high-throughput screening of enantiomeric excess (ee), comprising:

method for high-throughput screening of enantiomeric excess (ee), the method comprising the steps of:

a) elaborating an outer surface of a plurality of nanoparticles with at least one type of moiety which binds preferentially to a first member of an enantiomer pair compared to a second member of the enantiomer pair;

b) adding a chiral analyte, containing first and second enantiomer pairs, to a solution containing the plurality of nanoparticles, wherein said first member of the enantiomer pair competes effectively to bind with the at least one type of moiety while said second member of the enantiomer pair does not, and wherein said binding of said first member of the enantiomer pair to said at least one type of moiety responsively causes a discernable shift in the plasmon resonance band of the nanoparticles, wherein said plasmon resonance band of the nanoparticles is a strong, nanoparticle-based, absorption band in the visible region; and

c) detecting and quantifying said discernable shift wherein the extent of the discernable shift provides a rapid and effective measure of the enantiomer excess (ee) of the chiral analyte.

### BRIEF DESCRIPTION OF THE FIGURES

The present invention will now be described, by way of example only, reference being made to the accompanying drawings, in which:

FIG. 1 shows a sensor produced in accordance with the present invention, which is an aggregate of gold nanoparticles whose surfaces have been elaborated with chiral “hosts” and which are linked together by chiral “di-guests”;

FIG. 2 shows a generic representation of a detection system that relies on diastereoselective dispersion of nanoparticle aggregates. In this example, the aggregate is held in place by “di-guest” molecules. The enantiomer of the analyte at left does not cause dispersion, while that at right does. This representation is equivalent to that outline in detail in this patent;

FIG. 3 shows a generic representation of a detection system that relies on diastereoselective dispersion of nanoparticle aggregates. In this example, the aggreate is held in place by “di-host” molecules. The enantiomer of the analyte at left does not cause dispersion, while that at right does;

FIG. 4 shows a generic representation of a detection system that relies on diastereoselective dispersion of nanoparticle aggregates. In this example, the aggregate comprises two different nanoparticles—one elaborated with the “host”, the other with a tethered “guest”. The enantiomer of the analyte at left does not cause dispersion, while that at right does;

FIG. 5 shows a generic representation of a detection system that relies on diastereoselective aggregation of dispersed nanoparticles. One nanoparticle is elaborated with chiral “hosts”, while the other is elaborated with tethers whose solution facing terminii react with the chiral analyte to facilitate aggregation. In this example, the enantiomer of the analyte at left does not induce aggregation, while that at right does;

FIG. 6 shows a generic representation of a detection system that relies on diastereoselective aggregation of dispersed nanoparticles that is brought about by encapsulation of one enantiomer of the chiral analyte by surface-bound chiral hosts. In this example, the enantiomer of the analyte at left does not induce aggregation, while that at right does;

FIG. 7 shows a generic representation of a detection system that relies on diastereoselective aggregation of dispersed nanoparticles that is brought about by two molecules of a single enantiomer of the chiral analyte reacting with a tether to give a “di-guest” that brings the particles together by interacting with surface-bound “hosts” on different particles. In this example, the enantiomer of the analyte at left does not induce aggregation, while that at right does;

FIG. 8 shows the legend for FIGS. 2 to 7;

FIG. 9 shows the structures of chiral bisbinaphthyl-based hosts, 1a-c;

FIG. 10 shows the synthesis of the central precursor, 5;

FIG. 11 shows the syntheses of the bifunctional alkyl prescursors to the tether, 7a-c;

FIG. 12 shows the attachment of the bifunctional alkyl chains 7a-c to 5;

FIG. 13 shows the completion of the syntheses of the “hosts,” 1a-c;

FIG. 14 shows the synthesis of the diguest, (R,R)-14. The opposite enantiomer was made in the same way;

FIG. 15 shows dynamic light scattering (DLS) measurements of the aggregates produced when 33 nm host-coated gold nanoparticles are mixed with the enantiomers of the “di-guest,” (S,S)- and (R,R)-14, and (S)- and (R)-N-boc-protected alanine (whose structures are shown in FIG. 16);

FIG. 16 shows the structures of (S)- and (R)-N-boc-protected alanine;

FIG. 17 shows the absorbance at 650 nm as a function of time for 33 nm host coated nanoparticles exposed to solutions of either (S,S)- or (R,R)-14;

FIG. 18 shows the enantiomers of the bromoacids used in the competitive assay;

FIG. 19 shows the dependence of the absorption at 630 nm of solutions containing 1b-coated gold nanoparticles in the presence of a 1:1 molar equivalent of (R,R)-14 on the ee of added bromoacid (FIG. 18), and on time;

### DETAILED DESCRIPTION OF THE INVENTION

The systems described herein are directed, in general, to methods for high-throughput screening of enantiomeric excess (ee). Although embodiments of the present invention are disclosed herein, the disclosed embodiments are merely exemplary and it should be understood that the invention relates to many alternative forms. Furthermore, the Figures are not drawn to scale and some features may be exaggerated or minimized to show details of particular features while related elements may have been eliminated to prevent obscuring novel aspects. Therefore, specific structural and functional details disclosed herein are not to be interpreted as limiting but merely as a basis for the claims and as a representative basis for enabling someone skilled in the art to employ the present invention in a variety of manner. For purposes of instruction and not limitation, the illustrated embodiments are all directed to embodiments of methods for high-throughput screening of enantiomeric excess (ee).

As used herein, the term “about”, when used in conjunction with ranges of dimensions of particles or other physical properties or characteristics, is meant to cover slight variations that may exist in the upper and lower limits of the ranges of dimensions of particles so as to not exclude embodiments where on average most of the dimensions are satisfied but where statistically dimensions may exist outside this region. It is not the intention to exclude embodiments such as these from the present invention.

As used herein, the phrase “gold nanoparticles” means particles of gold whose diameters range from 1 to 1000 nm.

As used herein, the phrase “whose surfaces have been elaborated” means that organic groups have been chemically attached to the surfaces of the nanoparticles by way of a gold-thiolate bond, and that the nanoparticles retain their size and solubility following the attachment.

As used herein, the phrase “chiral molecular “host” means a molecule that can act as a container or dock for another molecule—the “guest”, and also that this molecule cannot be superimposed on its mirror image. A “di-host” is a molecule that may simultaneously act as a “host” for two different “guests”.

As used herein, the phrase “enantiomeric excess (ee)” means the percentage composition by which one enantiomer exceeds that of the other in a mixture of the two.

As used herein, the phrase “molecular guest” is a molecule that may be bound by a “host” through non-covalent interactions. These interactions are typically hydrogen bonds. A “di-guest” is a molecule that may simultaneously act as a guest for two different “hosts”.

The inventors have developed a wholly original method for high-throughput screening of enantiomeric excess (ee) that greatly facilitates the rapid discovery of new chiral catalysts for asymmetric reactions. The method disclosed herein relies on the visible colour change that occurs when aggregated gold nanoparticles are dispersed.

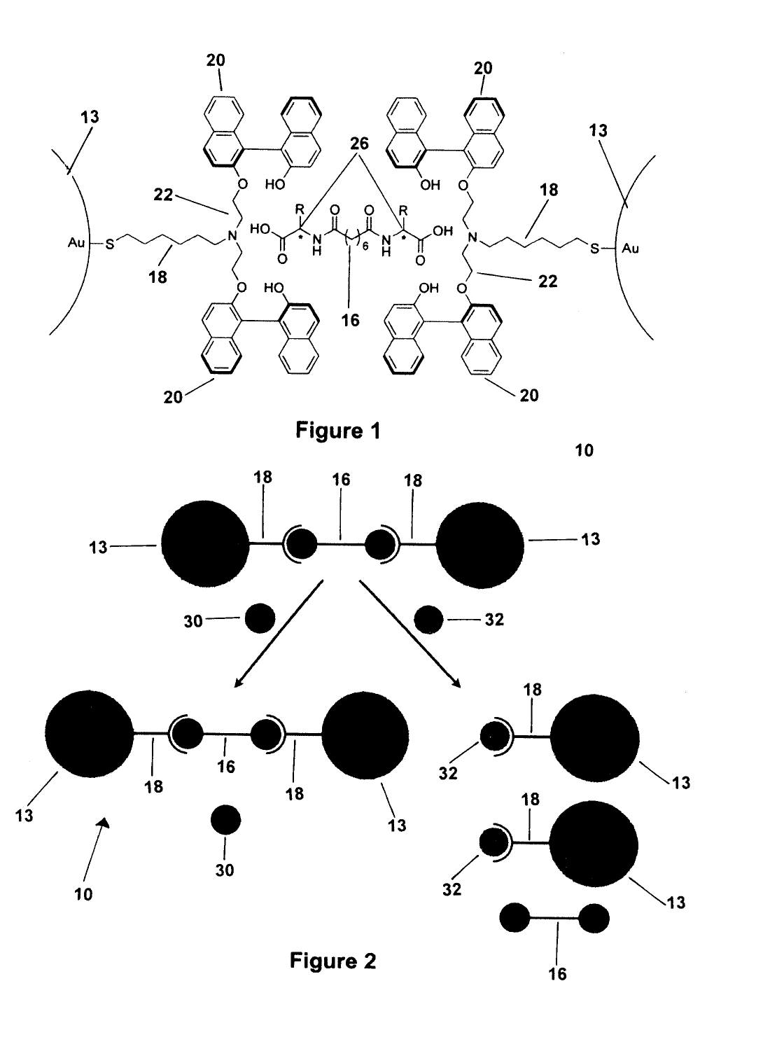

Referring first to FIGS. 1, 2 and the legend in FIG. 8, the basic principle is as follows: the sensor shown generally at 10 in FIGS. 1 and 2 is an aggregate of gold nanoparticles 13 whose surfaces have been elaborated with chiral “hosts” 18 and which are linked together by an amino-acid based “di-guest” 16 as illustrated in the FIG. 1 (equivalent to the generic mode shown in FIG. 2) with the “di-guest” 16 having two ends 18 each of which bonds with the chiral “host” 18 on the gold nanoparticles 13.

Hydrogen bonding interactions between these two ends 18 and their associated hosts 18 are responsible for holding the guest 16 within the hosts 18. The hosts 18 preferably comprise two optically pure binaphthol groups 20 (FIG. 1) linked together by a diethanolamine bridge 22 that is tethered via nitrogen N to a gold nanoparticle 13. Citrate supporting ligands on the surface of the gold nanoparticles 13 are not shown for clarity. Calculations indicate that the association constant for this host-guest interaction may be tuned by varying the size of the R groups on the amino-acid based “di-guest” 16, as well as by switching the absolute configuration of the chiral carbon atom 26 to which this R group is bound. If the association constant is adjusted precisely, then when the chiral analyte (the product of an asymmetric catalytic reaction, for example, but any particular chiral molecule, in principle) is added to a solution containing the aggregate, one enantiomer 30 will compete effectively with the “di-guest” 16 for the “host 18,” while the other enantiomer 32 will not. Thus, a diastereoselective dispersion of the aggregate will occur. This aggregation will bring about a large shift in the plasmon resonance band, which is a strong, nanoparticle-based, absorption band in the visible region, from a long wavelength for the aggregated nanoparticles to a shorter wavelength for the dispersed particles. The extent of this colour change will indicate the degree to which the particles are dispersed and provide a rapid and effective measure of the ee of the chiral analyte.

While the chiral host 18 has been illustrated using the two optically pure binaphthol groups 20 linked together by a diethanolamine bridge 22 that is tethered via nitrogen N to the gold nanoparticle, it will be appreciated that other chiral hosts may be used, including, but not limited to, cyclodextrins, calixarenes, cavitands, crytophanes and hemicryptophanes helicines and other species based on binaphthyl groups.

The structural and functional criteria that must be satisfied by the “hosts” include provision of a point of attachment to the nanoparticle, weak recognition of the “di-guest” and strong preferential recognition of one enantiomer of the target analyte.

The amino-acid based “di-guest” 16 shown in FIG. 1 is the product of the condensation of two generic amino acid residues with suberoyl chloride. It will be understood that this amino-acid based “di-guest” 16 is only meant to be exemplary and others may be used. For example, the range of R groups may extend to any of those found in the naturally-occurring or synthetic amino acids, and the length of the “linker” need not be 6 methylene (CH₂ groups): it may be any number. Also, the linker may also contain alkenyl, aryl, alkynl, ether, or other, elements as well as pendant groups.

The structural and functional criteria that must be satisfied by the “di-guests” include weak binding by the “host” and straightforward chemical tuning. In principle, it is not necessary for the “di-guest” to be chiral, but the inclusion of chiral centres allows for rapid expansion of the number of “di-guests”.

The invention will now be described for the purposes of illustrating the preferred modes known to the applicant at the time. The examples given herein are illustrative only and not meant to limit the invention, as measured by the scope and spirit of the claims. FIGS. 2 to 7 illustrate the possible generic modes of detection that should be clear to anyone practiced in the art. FIG. 8 shows the legend for the preceding figures.

FIG. 2 shows a generic representation of a detection system that relies on diastereoselective dispersion of nanoparticle aggregates. In this example, the aggregate 10 is held in place by “di-guest” molecules. The aggregate 10 is shown as including two nanoparticles 13 but it will be understood the aggregate 10 could contain numerous nanoparticles held together. The enantiomer 30 of the analyte at left does not cause dispersion, while enantiomer 32 that at the right does. This system would generate a blue-to-red colour change on successful detection, or would suppress the appearance of blue in a system to which the “di-guest” and target are added simultaneously, or nearly simultaneously. The representation in FIG. 2 is equivalent to that outlined in detail in this patent.

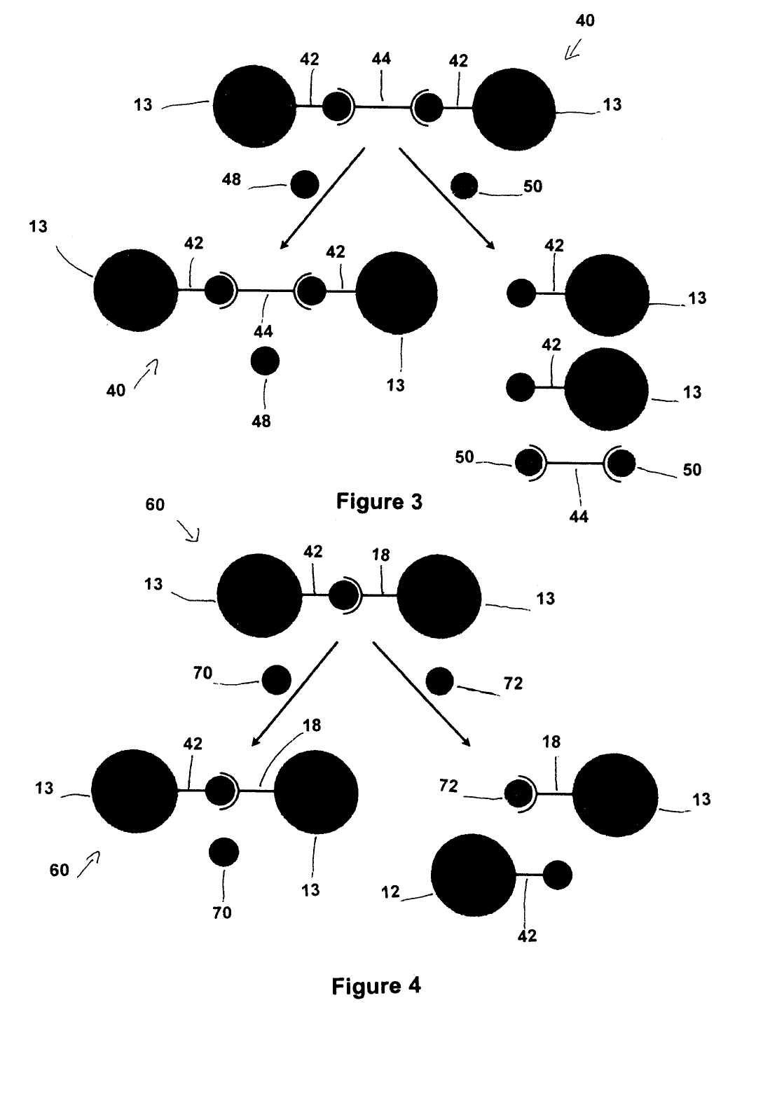

FIG. 3 shows another possible detection mode. It illustrates a generic detection system that relies, as does that shown in FIG. 2, on diastereoselective dispersion of nanoparticle aggregates 10. However, in this variation, the aggregate 40 is held in place by “di-host” molecules 44 instead of “di-guest” molecules 16 of FIG. 2 which hold guest coated nanoparticles comprised of the nanoparticle 13 and a guest molecule (optionally chiral) 42. The enantiomer 48 of the analyte at left does not cause dispersion, while enantiomer 50 at right does to produce two of the enantiomers 50 bound with the “di-host” molecule 44. Once again, this system would generate a blue-to-red colour change on successful detection, or would suppress the appearance of blue in a system to which the “di-host” and target are added simultaneously, or nearly simultaneously.

FIG. 4 shows a generic representation of another variation on a detection system that relies on diastereoselective dispersion of nanoparticle aggregates 60. The systems illustrated in each of FIGS. 2 and 3 rely on only one type of nanoparticle: either that elaborated with the chiral “host” (FIG. 2) or that elaborated with the chiral “guest” (FIG. 3). In this example, however, the aggregate comprises two different nanoparticles: one elaborated with the “host” 18, the other with a tethered “guest” 42. The aggregate 60 is formed by the association of the different nanoparticles mediated by the “host-guest” interaction. The enantiomer 70 of the target analyte at left does not cause dispersion, while enantiomer 72 at right does. Once again, this system would generate a blue-to-red colour change on successful detection, or would suppress the appearance of blue in a system to which the two different nanoparticles and the target analyte are added simultaneously, or nearly simultaneously.

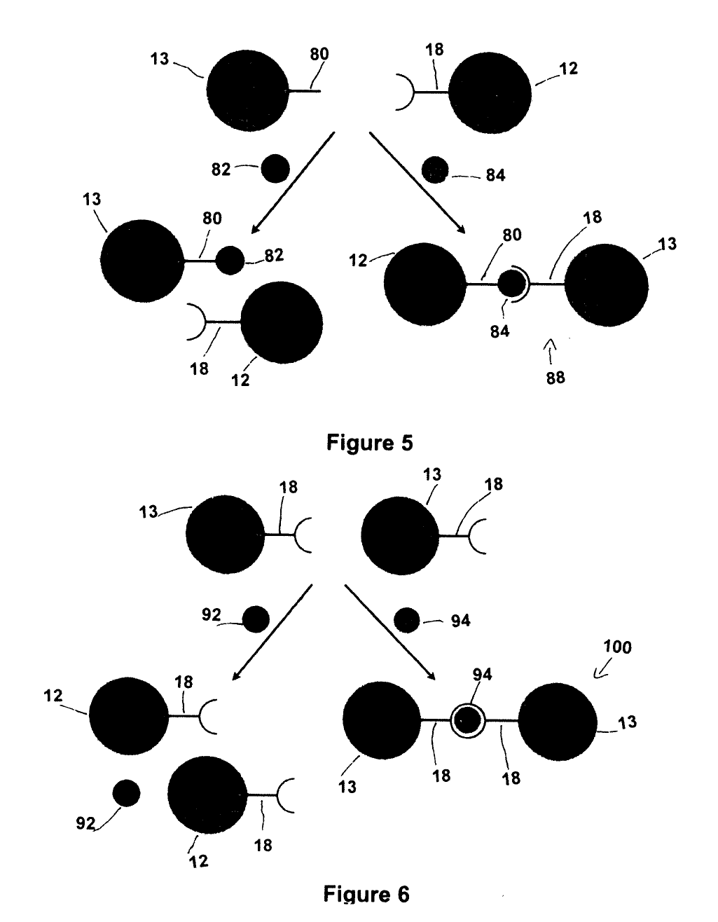

FIG. 5 turns the detection systems illustrated in FIGS. 2 to 4 “on their heads” by relying on diastereoselective aggregation of dispersed nanoparticles instead of on diastereoselective dispersion of nanoparticle aggregates. This system is comprised of two different particles: the first includes nanoparticles 13 elaborated with chiral “hosts” 18, while the other are nanoparticles 13 elaborated with “tethers” 80 whose solution facing termini react with the chiral analyte. One enantiomer 84 of the now nanoparticle-tethered analyte interacts with the chiral host 18 to a much greater extent than the other enantiomer 82 and diastereoselective aggeregation occurs. In this example, the enantiomer 82 of the analyte at left does not induce aggregation, while enantiomer 84 at right does to produce an aggregate 88. This system would generate a red-to-blue colour change on successful detection.

FIG. 6 shows a variation on a system that relies, like that shown in FIG. 5, on the diastereoselective aggregation of dispersed nanoparticles. Here, encapsulation of one enantiomer 94 of the chiral analyte by surface-bound chiral hosts brings about the diastereoselective aggregation. In this example, the enantiomer 92 of the analyte at left does not induce aggregation, while that at right does to produce an aggregate 100. Once again, this system generates a red-to-blue colour change on successful detection.

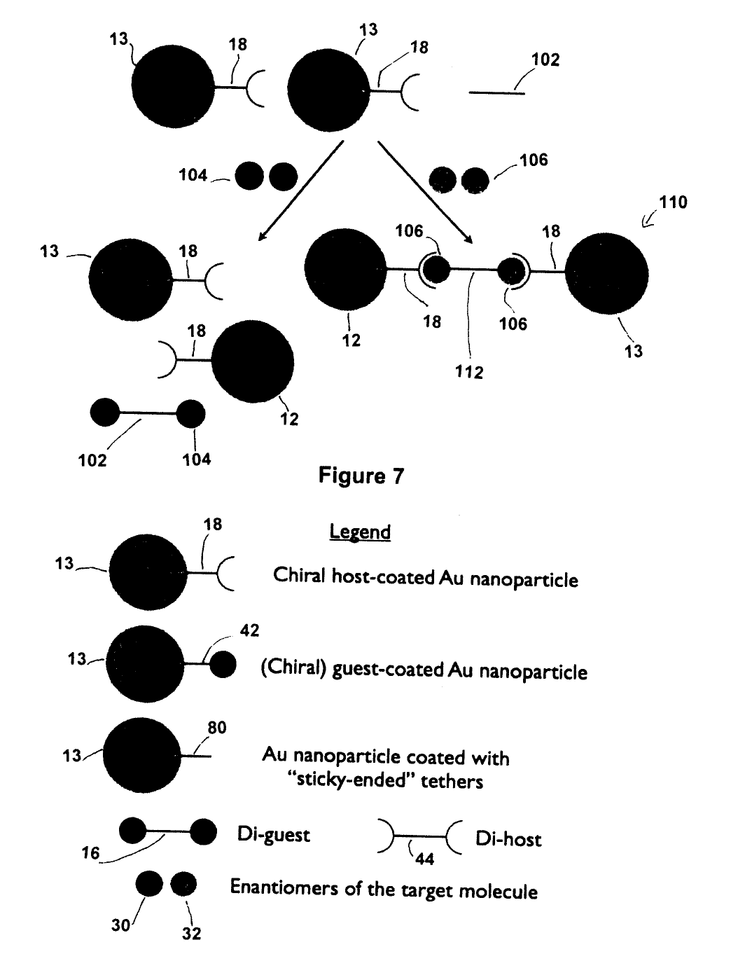

FIG. 7 shows a generic representation of a detection system that relies, like those shown in FIGS. 5 and 6, on diastereoselective aggregation of dispersed nanoparticles. In this mode, however, the aggregation is brought about by two molecules of a single enantiomer 106 of the chiral analyte reacting with a tether 102 to give a “di-guest” 112. This “di-guest” 112 brings the particles together through diastereoselective interactions with surface-bound “hosts” 18. In this example, the enantiomer 104 of the analyte at left does not induce aggregation, while enantiomer 106 that at right does to produce an aggregate 110. Once again, this system would generate a red-to-blue colour change on successful detection.

As mentioned above, the “classical” methods for ee determination are the following: (1) covalent attachment of enantiopure derivitising agents followed by measurement of diastereomeric excess (de), typically by NMR spectroscopy; (2) detection of transient, non-covalent interactions between the target molecule and a chiral-shift reagent, also by NMR spectroscopy, or through use of chiral solvents; and (3) the use of chiral stationary phases in gas and high performance liquid chromatography (GC and HPLC.) This last technology constitutes the current state of the art, both in generality and accuracy.

Chromatographic techniques, however, are hampered by their relative slowness and difficulty of parallelization. For example, a single GC analysis may take 15 min. (a conservative estimate that does not include preparation time). If 96 different catalysts are to be analyzed (as would result from microscale reactions on a 6×16 well plate), the total analysis time would be 24 h. The only way to speed this process would be to acquire more GC instruments, which would be prohibitively expensive in most instances. Because it is an in situ technique that does not require specialized and costly equipment to separate enantiomers and because it relies on simple color changes in the human-visible region of the spectrum, our method would allow the rapid screening of large numbers of catalysts. It may even be possible to perform crude analyses with the naked eye. Even if the system cannot be made quantitative, a rapid qualitative analysis would allow immediate identification of lead catalyst candidates whose reaction products could be analyzed quantitatively by the existing chromatographic methods in a subsequent step. This would negate screening every catalyst by slow and expensive techniques and thereby narrow the field to include only the most promising candidates.

The inventors are, to date, not aware of any other efforts to use gold or other nanoparticles in a sensing system for ee. It is contemplated by the inventors that silver particles could also be used, and this patent should not be limited to the used of gold nanoparticles alone.

There is therefore enormous potential for practical and rapid ee determination protocols in the combination of gold nanoparticles with chiral recognition.

The chemical advantages of an ee determination system based on gold nanoparticles as disclosed herein are as follows. The modular design of the system allows for variation of several parameters: a) the size of the nanoparticles; b) the length and chemical nature of the tethers connecting the nanoparticles to the chiral “host”; c) the shape of the chiral “host”; d) the identity and chirality of the amino acid “di-guest”; and e) the length and nature of the tether bridging the “di-guest's” two heads. The underlying chemistry of these aspects has already been determined in detail by other groups. The inventors have therefore been able to use the best known materials and protocols for the individual components, and have combined them in a unique fashio to make a (set of) functional detection system(s). Another advantage is very low detection limits on account of the enormous absorption coefficients (10⁸−10¹¹ M⁻¹ cm⁻¹) of the surface plasmon band of gold nanoparticles.

Practical advantages include: the potential for in situ screening. Because of the very large absorption coefficients, it is likely that the colour of the nanoparticles in their monodispersed state will completely overpower any colour of a catalytic reaction mixture. For crude analysis of whether or not a particular reaction “worked,” i.e., gave substantial ee, it should be sufficient simply to add the nanoparticles to the mixture and conduct a visual inspection. There is the capability for rapid screening. The kinetics of recognition of the analyte by the aggregate make it likely that this system will provide significant time gains in most cases when compared to other methods of detection, like GC and HPLC. There is the capability for parallel screening. In the first instance, it should be possible, simply by visual inspection, to discard those reactions that have not worked.

The following outlines the methods used to make the system, and the specific results for the determination of the ee of solutions of modified amino acids.

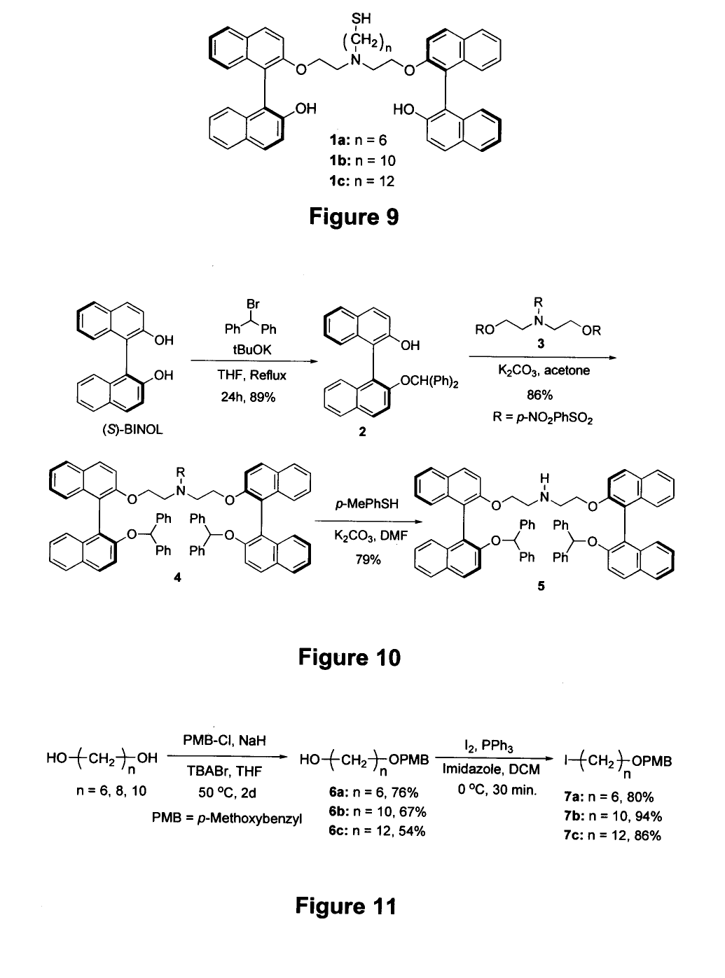

The “hosts” (1a-1c) in this system were the chiral bisbinaphthyl compounds shown in FIG. 9. These molecules were synthesized in several steps. The central precursor for the synthesis of chiral bisbinaphthyl-based receptors 1a-c was prepared using a modified procedure introduced by Pu et al. [1] Reaction of (S)-1,1′-bi-2-naphthol [(S)-BINOL] with t-BuOK followed by treatment with benzhydryl bromide for steric reasons gave mainly mono-protected BINOL 2 in 89% yield (FIG. 10). [2] This compound was then reacted with the known compound 3 [3] in the presence of K₂CO₃ in refluxing acetone to form the bisbinaphthyl compound 4 in 86% yield. Removal of the p-nitrosulfonyl group of compound 4 with 4-methylbenzenethiol [4] furnished the central precursor 5 in 79% yield.

The synthesis of bifunctional alkyl chains of varying chain lengths is outlined in FIG. 11. Treatment of the corresponding diol with p-methoxybenzyl chloride in the presence of NaH and a catalytic amount of tetrabutylammonium bromide gave mono-protected diols 6a-c. Iodination of 6 with I₂ and PPh₃ in the presence of imidazole resulted iodide 7a-c in high yield (80-90%).

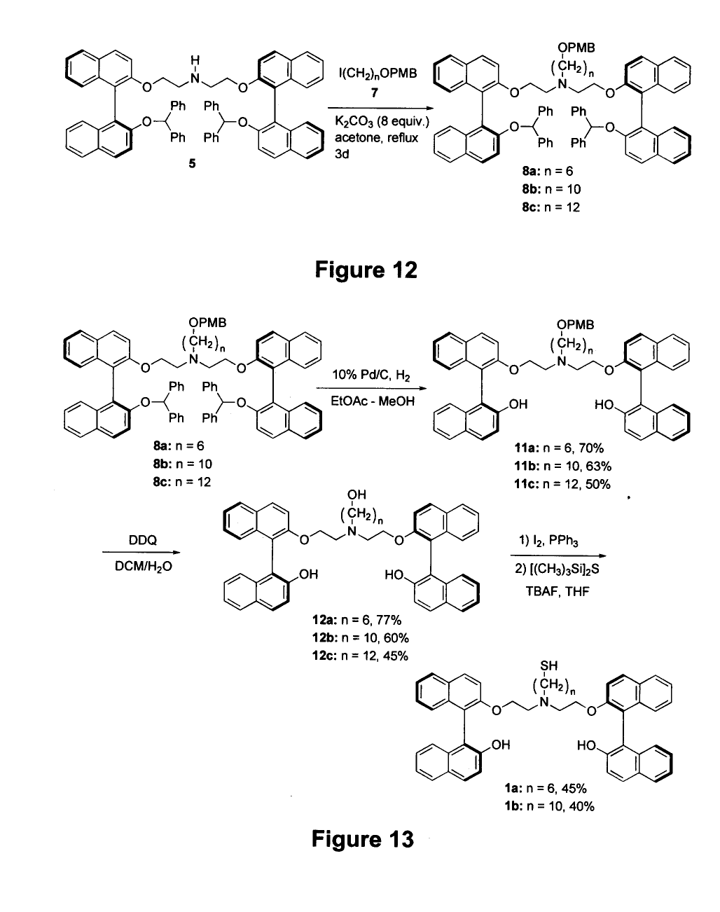

The precursor 5 was alkylated with 7a-c using the optimized conditions of 3 days at reflux in acetone solvent with 8.0 mol equiv. of K₂CO₃ as base (FIG. 12).

Benzhydryl deprotection was carried out successfully when 8a was treated with 10% Pd/C-H₂ using EtOAc-MeOH (1/1) as a solvent (FIG. 13). Oxidative removal of the PMB group with DDQ gave the alcohol 12a. Selective iodination [10] of the primary alcohol followed by reaction with hexamethyidisilathiane with TBAF afforded the thiol 1a in 45% yield for two steps. Similarly, 1b and 1c were synthesized from 8b and 8c respectively.

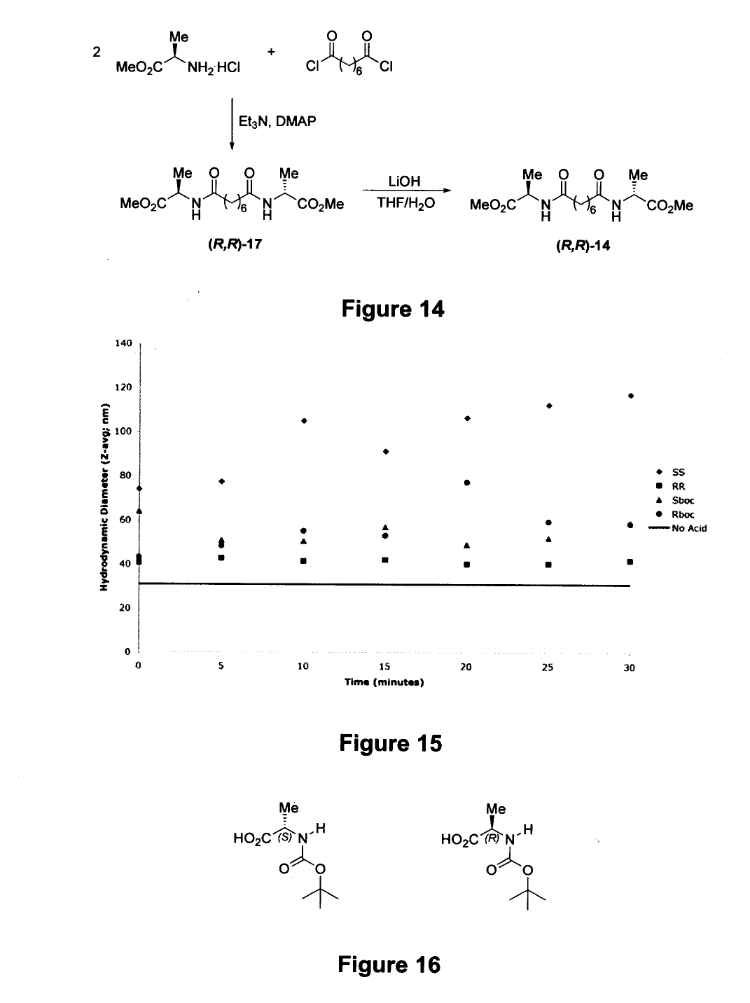

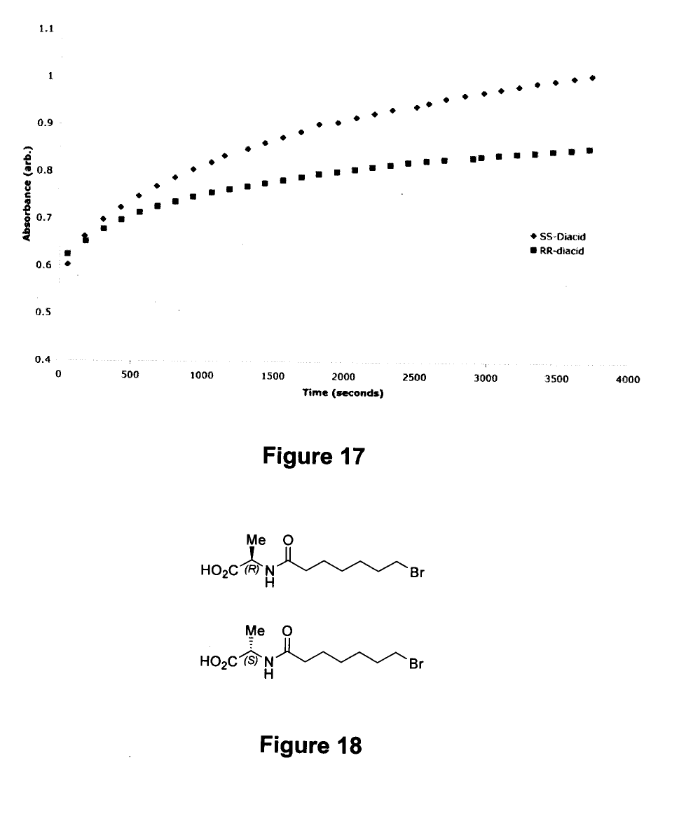

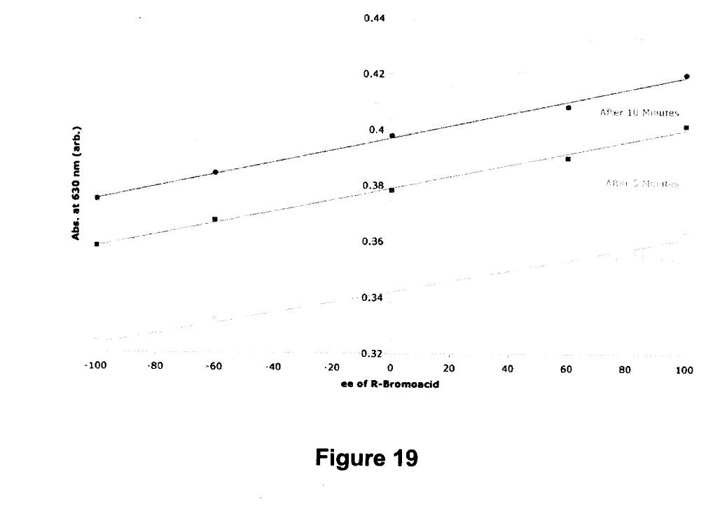

Both enantiomers of the di-guest (S,S)- and (R,R)-14 were made according to FIG. 14. The synthesis involved amide bond formation between the enantiomers of O-methylalanine and suberoyl chloride, followed by hydrolysis of the resultant diesters (S,S)- and (R,R)-14.

The precursor to the final detection system was assembled by binding the “host” 1a-c to the surface of gold nanoparticles. Colloidal gold solutions were prepared by the reduction of HAuCl₄ by sodium citrate according to a standard procedure [6]. A 25 mL sample of colloidal gold solution thus prepared was placed in a 100 mL round-bottom flask and the pH was adjusted to approximately 10.0 by addition of 3 M NaOH solution. Compound 1b (1 mg, 1.23×10⁻³ mmol) dissolved in 1 mL of CH₂Cl₂ was added, and the mixture was stirred at room temperature for 2 days. The aqueous fraction was then washed with CH₂Cl₂ (3×20 mL) to remove unbound 1b, isolated and used without further work-up in subsequent experiments. Gold nanoparticles coated with other hosts were prepared similarly.

Enatiomer of the “di-guest” were differentiated by the “host”-coated gold nanoparticles prepared above, i.e., the aggregates were formed diastereo-selectively by the interaction between one enantiomer of a “di-guest” molecule and host-coated gold nanoparticles. The chiral detection system is shown in FIG. 1.

FIG. 15 shows by dynamic light scattering (DLS) the aggregation that results from reaction of 10 mg/mL of dialanine guest (or equivalent N-boc-protected alanine, FIG. 4) in 1 mL of water (pH adjusted to 6.8) with 1 mL of a 20-fold dilution of 33 nm 1b-coated nanoparticles. Clearly, the S,S-enantiomer of the diguest produces much larger aggregates (120 nm) over time than the R,R-enantiomer. Neither of the two enantiomers of N-boc-protected alanine produce aggregates because these mono-acids are incapable of bridging two nanoparticles. (Hydrodynamic diameters are always slightly larger than the diameters measured by microscopy because they take into account solvation shells.)

FIG. 16 clearly shows the difference between S,S and R,R “di-guest” detection by 33 nm host-coated nanoparticles in terms of UV-visible absorption spectroscopy. The surface plasmon absorption of aggregated particles lies at 650 nm: higher absorption at this wavelength means greater aggregation. From the visible and absorption data, it is obvious that the host is ultimately more selective for the S,S-guest than for the R,R-.

The following experiment constitues the proof-of-principle for the invention described herein (and corresponds in principle to the generic scheme shown in FIG. 2). It involved mixing 1 mL of an aqueous solution of 1b-coated nanoparticles with 1 mL of a mixture of the diguest (R,R)-14 (0.25 mg mL⁻¹) and the appropriate enantiomeric excess (ee) of the bromoacids shown in FIG. 6 (0.21 mg mL⁻¹) in methanol so that the molar ratio between (R,R)-14 and the bromoacid was 1:1. The experiments were performed at room temperature.

The principle was as follows: the diguest is capable of bridging the particles and causing aggregates to form. However, (R,R)-14 does this only poorly (see above). The bromoacids shown in FIG. 6 mimic (R,R)-14 in terms of size and electronic character; however, they are unable to bridge the nanoparticles because they possess an acid functional group at only one end. If either of the two enantiomers of the bromoacid binds 1b more tightly than (R,R)-14, the formation of aggregates will be suppressed selectively, and therefore the optical absorption at 630 nm (where aggregates absorb) will be weak when this is the case.

FIG. 7 shows the dependence of the absorption at 630 nm on the ee of the (R)-bromoacid, and on time. Clearly, and as expected (Section 6) the (S)-bromoacid binds 1b much more tightly than the (R)-. Therefore, the absorption at 630 nm of solutions containing pure (S)-bromoacid (ee=−100%) is very low: aggregation is suppressed when the concentration of (S)-bromoacid is high. Conversely, solutions containing pure (R)-bromoacid (ee=100%) have intense absorption at 630 nm.

It is also apparent that the absorbance at 630 nm depends on time. So, comparisons between bromoacid solutions of different ee are only valid at the same points in time following addition to the nanoparticle-containing solution. The lines shown in FIG. 7 are essentially calibration curves for the bromoacids.

The biggest value in using this dispersion approach is that the host, which is difficult to make, can be kept constant across a range of different chiral targets. The detection relies only on a difference between the affinity of the two enantiomers of the target and the bridging diguest. This affinity can be tweaked either by switching the diguest (which requires only simple synthetic chemistry), or, without doing chemistry at all, by altering the physical parameters of the experiment, like temperature and concentration.

The following paragraphs describe the exact techniques of chemical synthesis and the characterization of the as yet unreported compounds relevant to this patent.

4. Under nitrogen, to a stirred solution of monoprotected (S)-BINOL 2 (16.0 g, 37.85 mmol) in acetone (200 mL), linker 3 (10.0 g, 15.14 mmol) and K₂CO₃ (31.68 g, 229.22 mmol) were added. The mixture was then heated at reflux for 24 h. After the reaction was cooled to room temperature, water was added and the solution was extracted with EtOAc. The organic layer was dried (Na₂SO₄), filtered, and concentrated under reduced pressure. Purification of the residue by column chromatography (10-30% EtOAc/hexane) gave the pure compound 4 (16.32 g) in 93% yield; amorphous. ¹H NMR (CDCl₃): δ 2.42-2.60 (m, 4H), 3.20-3.45 (m, 4H), 6.01 (s, 2H), 6.65-7.34 (m, 40H), 7.40-7.88 (m, 8H).

5. Under nitrogen, to a stirred solution of 4 (15.0 g, 12.94 mmol) in DMF (250 mL) were added K₂CO₃ (7.15 g, 51.76 mmol) and 4-methylbenzenethiol (3.21 g, 25.88 mmol). After being stirred at room temperature overnight, the reaction was quenched by addition of water. The aqueous layer was extracted with EtOAc, and the combined organic solution was washed with 1 M NaOH and water, and then dried over Na₂SO₄. After removal of the solvent, the crude product was purified by column chromatography (40% EtOAc/hexanes) to give 5 (11.47 g) in 91% yield; amorphous. ¹H NMR (CDCl₃): δ 1.98-2.18 (m, 4H), 3.40-3.59 (m, 4H), 6.10 (s, 2H), 6.80-7.38 (m, 36H), 7.70 (dd, 4H), 7.90 (dd, 4H). Mass (m/z) 973 (M⁺), 521, 286; HRMS calcd. for C₇₀H₅₅NO₄: 973.4131; found: 973.4105.

8a-c. The preparation of 8a is typical. To a solution of 5 (1.0 g, 1.03 mmol) in acetone (40 mL), K₂CO₃ (1.14 g, 8.24 mmol) was added and the mixture was brought to reflux for 30 min under nitrogen. After cooling to room temperature, a solution of iodide 7a (896 mg, 2.57 mmol) in acetone (10 ml) was added slowly and the mixture was again heated to reflux for 3 days. After cooling once more to room temperature, water was added and the solution was extracted with EtOAc. The organic layer was dried (Na₂SO₄), filtered, and concentrated under reduced pressure. Purification of the residue by column chromatography (10-30% EtOAc/hexanes) gave the pure compound 8a (1.17 g) in 95% yield; amorphous. Mass (m/z) 1194 (M+H)⁺, 546, 409. HRMS calcd. for C₈₄H₇₅NO₆: 1194.5678; found: 1194.5680.

8b: 79% yield. ¹H NMR (CDCl₃): δ 0.71-0.79 (m, 4H), 0.97-1.42 (m, 10H), 1.65-1.78 (m, 4H), 2.19 (br s, 4H), 3.45-3.65 (m, 6H), 3.80 (s, 3H), 4.48 (s, 2H), 6.12 (s, 2H), 6.9-7.38 (m, 40H), 7.73 (dd, J=8.8, 7.6, 4H), 7.94 (t, J=8.8, 4H). Mass (m/z) 1250 (M⁺); HRMS calcd. for C₈₈H₈₃NO₆: 1250.6299; found: 1250.6293.

8c: 81% yield. ¹H NMR (CDCl₃): δ 0.71-0.79 (m, 4H), 1.19-1.45 (m, 14H), 1.65-1.78 (m, 4H), 2.19 (br s, 4H), 3.45-3.65 (m, 6H), 3.80 (s, 3H), 4.48 (s, 2H), 6.12 (s, 2H), 6.9-7.38 (m, 40H), 7.73 (dd, J=8.8, 7.6, 4H), 7.94 (t, J=8.8, 4H); ¹³C NMR δ 26.56, 27.28, 27.86, 29.99, 52.75, 55.44, 68.33, 70.54, 72.81, 82.53, 114.04, 115.11, 117.32, 119.92, 121.97, 123.64, 125-131.10 (m), 134.45, 142.20, 153.49, 154.87, 159.38. Mass (m/z) 1278 (M⁺), 549, 509; HRMS calcd. for C₉₀H₈₇NO₆: 1278.6645; found: 1278.6631.

11a-c. The preparation of 11a is typical. To a solution of 8a (1.0 g, 0.84 mmol) in EtOAc-MeOH (1/1, 40 mL), 10% Pd/C (300 mg) was carefully added and stirred at room temperature for 4 days under H₂ balloon. The Pd was filtered off and the filtrate was reduced to dryness in vacuo. The crude material was purified by column chromatography (60% EtOAc/hexanes) to afford the product 11a (587 mg) in 81% yield. ¹H NMR (CDCl₃): δ 0.78-1.15 (m, 6H), 1.32-1.41 (m, 2H), 1.88-2.15 (m, 2H), 2.19-2.30 (m, 2H), 2.31-2.42 (m, 2H), 3.30 (t, J=8.8, 2H), 3.58-3.78 (m, 7H), 4.45 (s, 2H), 6.87-7.38 (m, 22H), 7.80-7.95 (m, 8H). Mass (m/z) 862 (M⁺), 550, 242; HRMS calcd. for C₅₈H₅₅NO₆: 862.4081; found: 862.4073.

11b: 63% yield. ¹H NMR (CDCl₃): δ 0.82-1.42 (m, 14H), 1.59-1.72 (m, 2H), 1.96-2.18 (m, 2H), 2.25-2.35 (m, 2H), 2.44-2.58 (m, 2H), 3.45 (t, J=8.8, 2H), 3.60-3.78 (m, 7H), 4.35 (s, 2H), 6.87-7.38 (m, 22H), 7.80-7.94 (m, 8H). Mass (m/z) 918 (M⁺), 749, 509, 219; HRMS calcd. for C₆₂H₆₃NO₆: 918.4734; found: 918.4724.

11c: 50% yield. ¹H NMR (CDCl₃): δ 0.81-1.38 (m, 18H), 1.48-1.62 (m, 2H), 1.93-2.42 (m, 2H), 2.23-2.35 (m, 2H), 2.46-2.57 (m, 2H), 3.43 (t, J=8.8, 2H), 3.68-3.84 (m, 7H), 4.45 (s, 2H), 6.86-7.37 (m, 22H), 7.80-7.94 (m, 8H). ¹³C NMR: δ 26.46, 27.40, 27.86, 29.82, 51.75, 55.49, 70.47, 72.73, 113.96, 114.88, 117.17, 119.22, 123.48, 129.65, 130.62, 134.22, 151.86, 154.81. Mass (m/z) 946 (M⁺); HRMS calcd. for C₆₄H₆₇NO₆: 946.5022; found: 946.5020.

12a-c. The preparation of 12a is typical. To an ice-cold mixture of PMB ether 11a (400 mg, 0.46 mmol) in DCM/H₂O (10/1, 11 mL) was added 2,3-dichloro-5,6-dicyano-1,4-benzoquinone (DDQ, 211 mg, 0.92 mmol) in one portion. The mixture was stirred at 0° C. for 1.5 h, and diluted with saturated NaHCO₃. The organic layer was separated, and the aqueous layer was extracted with CH₂Cl₂. The combined organic layers were dried over Na₂SO₄ and concentrated to afford a residue, which was purified by column chromatography (70% EtOAc/hexanes) to furnish alcohol 12a (264 mg) in 77% yield. ¹H NMR (CDCl₃): δ 0.78-1.15 (m, 6H), 1.32-1.41 (m, 2H), 1.88-2.15 (m, 2H), 2.19-2.30 (m, 2H), 2.31-2.42 (m, 2H), 3.42 (t, J=6.8, 2H), 3.61-3.78 (m, 4H), 4.45 (s, 2H), 6.87-7.38 (m, 18H), 7.78-7.95 (m, 8H). Mass (m/z) 842 (M⁺), 639, 430, 242; HRMS calcd. for C₅₀H₄₇NO₅: 742.3532; found: 742.3535.

12b: 60% yield. ¹H NMR (CDCl₃): δ 0.82-1.52 (m, 16H), 1.74-1.72 (m, 2H), 1.76-2.02 (m, 2H), 2.22-2.45 (m, 4H), 3.43 (t, J=6.8, 2H), 3.50-3.78 (m, 4H), 6.87-7.42 (m, 18H), 7.58-7.94 (m, 8H). Mass (m/z) 798 (M⁺), 549; HRMS calcd. for C₅₄H₅₅NO₅: 798.4181; found: 798.4185

12c: 45% yield. ¹H NMR (CDCl₃): δ 0.77-1.31 (m, 18H), 1.45-1.49 (m, 2H), 1.86-2.20 (m, 2H), 2.23-2.35 (m, 2H), 2.46-2.57 (m, 2H), 3.54 (t, J=6.8, 2H), 3.64-3.73 (m, 4H), 6.87-7.29 (m, 18H), 7.73-7.86 (m, 8H). Mass (m/z) 826 (M⁺), 549; HRMS calcd. for C₅₆H₅₉NO₅: 826.4431; found: 826.4441.

1a-c. The preparation of 1a is typical. Under nitrogen, to a solution of alcohol 10 (200 mg, 0.27 mmol) in CH₂Cl₂ (10 mL), imidazole (55 mg, 0.81 mmol) and PPh₃ (212 mg, 0.87 mmol) were added and the mixture was stirred at room temperature for about 10-15 min. The reaction mixture was then cooled to 0° C. and I₂ (137 mg, 0.54 mmol) was added. After being stirred at 0° C. for 1 h, the reaction was quenched with 1 M HCl. The resultant mixture was diluted with CH₂Cl₂, washed with water and brine, dried (Na₂SO₄), filtered, and concentrated under reduced pressure to give the crude iodide, which was used in the next step without further purification.

To a stirred solution of the iodide in THF (5 mL), a mixture of ⁿBu₄NF (92 mg, 0.35 mmol) and hexamethyldisilathiane (85 μL, 0.41 mmol) in THF (5 mL) were added and the mixture was stirred at 0° C. for 30 min at the same temperature before being allowed to warm to room temperature. After 12 h, 1 M HCl was added. The reaction mixture was diluted with CH₂Cl₂, washed with a saturated NH₄Cl solution, water and brine, dried (Na₂SO₄), filtered, and concentrated under reduced pressure. The crude material was purified by column chromatography (70% EtOAc/hexanes) to give the pure thiol 1a in 45% overall yield over 2 steps. ¹H NMR (CDCl₃): δ 0.65-1.15 (m, 6H), 1.32-1.58 (m, 2H), 1.88-1.98 (m, 2H), 2.19-2.42 (m, 4H), 3.42 (t, J=6.8, 2H), 3.61-3.82 (m, 4H), 6.87-7.38 (m, 18H), 7.78-7.95 (m, 8H). Mass (m/z) 760 (M⁺); HRMS calcd. for C₅₀H₄₇NO₄S: 760.3477; found: 760.3461.

1b: 40% yield. ¹H NMR (CDCl₃): δ 0.65-1.18 (m, 14H), 1.62-1.78 (m, 2H), 1.80-2.02 (m, 2H), 2.18-2.45 (m, 4H), 3.43 (t, J=6.8, 2H), 3.50-3.78 (m, 4H), 6.87-7.42 (m, 18H), 7.58-7.94 (m, 8H). Mass (m/z) 816 (M⁺); HRMS calcd. for C₅₄H₅₅NO₄S: 816.3744; found: 816.3750.

(S,S)- and (R,R)-17. To a solution of Ala-OMe.HCl (2.50 g, 26.05 mmol) in dry CH₂Cl₂ (60 mL), Et₃N (7.43 mL, 53.28 mmol) and DMAP (29.0 mg, 0.24 mmol) were added at 0° C. A solution of suberoyl chloride (2.50 g, 11.84 mmol) in CH₂Cl₂ (10 mL) was added dropwise and the mixture was stirred at room temperature overnight. The reaction mixture was quenched with water, extracted with CH₂Cl₂ (×2), washed with 1 M HCl, water and brine. The residue was dried over MgSO₄ and evaporated in vacuo to give the crude product which was purified by crystallization from EtOAc.

(R,R)-17: 64% yield; white powder. ¹H NMR (CDCl₃): δ 1.24-1.27 (m, 4H), 1.35 (d, J=7.2, 6H), 1.46-1.69 (m, 4H), 2.18 (t, J=7.6, 4H), 3.73 (s, 6H), 4.58 (dt, J=7.2, 2H), 6.31 (d, J=7.6, 2H); ¹³C NMR δ 18.54, 25.42, 28.54, 36.21, 47.99, 52.62, 172.87, 174.11; Mass (m/z) 344 (M⁺), 285, 242; HRMS calcd. for C₁₆H₂₈N₂O₆: 344.1947; found: 344.1941.

(S,S)-17: 70% yield; white powder. Spectroscopic data were identical to those of the (R,R)-isomer.

(S,S)- and (R,R)-14. To a solution of ester 17 (0.95 g, 2.76 mmol) in THF/H₂O (4/1, 20 mL), LiOH (0.29 g, 6.89 mmol) was added at 0° C. The resulting mixture was stirred at the same temperature for about 1 h and then at room temperature for 3 h. Finally, the solution was quenched with 1 N HCl, evaporated in vacuo to remove the solvent, and extracted with EtOAc (×10). The combined organic fractions were dried over MgSO₄ and evaporated to give the crude product, which was purified by crystallization from MeOH/EtOAc.

(R,R)-14: 83% yield; white powder. ¹H NMR (D₂O) δ 1.11-1.15 (m, 4H), 1.22 (d, J=7.2, 6H), 1.38-1.46 (m, 4H), 2.18 (t, J=7.2, 4H), 4.15 (q, J=7.2, 2H). Mass (m/z) 316 (M⁺), 272, 228. HRMS calcd. for C₁₄H₂₄N₂O₆: 316.1634; found: 316.1639.

(S,S)-14: 46% yield; white powder. Spectroscopic data were identical to those of the (R,R)-isomer.

As used herein, the terms “comprises”, “comprising”, “including” and “includes” are to be construed as being inclusive and open ended, and not exclusive. Specifically, when used in this specification including claims, the terms “comprises”, “comprising”, “including” and “includes” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

1. A method for high-throughput screening of enantiomeric excess (ee), the method comprising the steps of:
a) elaborating an outer surface of a plurality of nanoparticles with at least one type of moiety which binds preferentially to a first member of an enantiomer pair compared to a second member of the enantiomer pair;
b) adding a chiral analyte, containing first and second enantiomer pairs, to a solution containing the plurality of nanoparticles, wherein said first member of the enantiomer pair competes effectively to bind with the at least one type of moiety while said second member of the enantiomer pair does not, and wherein said binding of said first member of the enantiomer pair to said at least one type of moiety responsively causes a discernable shift in the plasmon resonance band of the nanoparticles, wherein said plasmon resonance band of the nanoparticles is a strong, nanoparticle-based, absorption band in the visible region; and
c) detecting and quantifying said discernable shift wherein the extent of the discernable shift provides a rapid and effective measure of the enantiomer excess (ee) of the chiral analyte.

2. The method according to claim 1 wherein said at least one type of moiety is a chiral molecular host, comprising molecular guest molecules bound between molecular hosts on different nanoparticles to form a sensor comprising aggregates of nanoparticles wherein individual nanoparticles in the aggregates are linked together by “host-guest” interactions, and wherein in step b) upon exposing said aggregates to said chiral analyte said first member of the enantiomer pair competes effectively with the “guest” for the “host,” while the second member of the enantiomer pair does not, and wherein a diastereoselective dispersion of the aggregate occurs which responsively causes a discernable shift in the plasmon resonance band of the nanoparticles, from a long wavelength for the aggregated nanoparticles to a shorter wavelength for the dispersed particles.

3. The method according to claim 2 wherein said chiral “host” is selected from the group consisting of binaphthyl-based compounds, cyclodextrins, calixarenes, cavitands, cryptophanes and hemicryptophanes and helicines.

4. The method according to claim 2 wherein the said chiral host is tethered to its associated nanoparticle by a molecular tether and wherein the molecular tether may be of any length.

5. The method according to claim 4 wherein said molecular tether is selected from the group consisting of methylenes, alkenyls, aryls, alkynyls, ethers, esters, amides and ketones.

6. The method according to claim 2 wherein said chiral molecular “host” includes two optically pure binaphthol groups linked together by a diethanolamine bridge that is tethered via nitrogen to its associated nanoparticle by way of a hexamethylene thiolate residue.

7. The method according to claim 2 wherein the molecular guest is a molecule possessing either hydrogen bond donor or hydrogen bond acceptor characteristics, or both, and wherein the molecular guest may or may not be chiral.

8. The method according to claim 7 wherein the molecular guest is a molecule containing two amino acid residues linked together by a molecular bridging unit and wherein the amino acids are selected from the group consisting of all naturally-occurring and synthetic amino acids, and wherein the bridging unit may be of any length.

9. The method according to claim 8 wherein the bridging unit is selected from the group consisting of methylenes, alkenyls, aryls, alkynyls, ethers, esters, amides and ketones.

10. The method according to claim 7 wherein the molecular guest is a product of the diamide product of (R)-alanine and suberoyl chloride.

11. The method according to claim 1 wherein said at least one type of moiety is a molecular guest, comprising a chiral di-host molecule bound between molecular guests on different nanoparticles to form a sensor comprising aggregates of nanoparticles wherein individual nanoparticles in the aggregates are linked together by “guest-host” interactions, and wherein upon exposing said aggregates to said chiral analyte in step b) said first member of the enantiomer pair competes effectively with the molecular guest for the “di-host” molecules while the second member of the enantiomer pair does not, and wherein a diastereoselective dispersion of the aggregate occurs which responsively causes a discernable shift in the plasmon resonance band of the nanoparticles, from a long wavelength for the aggregated nanoparticles to a shorter wavelength for the dispersed particles.

12. The method according to claim 11 wherein said chiral di-host molecule is selected from the group consisting of binaphthyl-based compounds, cyclodextrins, calixarenes, cavitands, cryptophanes and hemicryptophanes and helicines.

13. The method according to claim 12 wherein the chiral di-host molecule include a first pair of two optically pure binaphthol groups linked together by a diethanolamine bridge that is tethered via nitrogen to second pair of binaphthol groups that are also linked together by a diethanolamine bridge by the nitrogen atom in the second pair which pair constitutes the di-host, and wherein a linker molecule between two heads of the chiral di-host molecule may be of any length.

14. The method according to claim 13 wherein the said linker molecule between two heads of the “di-host” may be selected from the group consisting of methylenes, alkenyls, aryls, alkynyls, ethers, esters, amides and ketones.

15. The method according to claim 11 wherein the said molecular guest is a molecule possessing either hydrogen bond donor or hydrogen bond acceptor characteristics, or both, and wherein the molecular guest may or may not be chiral.

16. The method according to claim 11 wherein the molecular guest contains an amino acid residue that is tethered by a molecular tether to the nanoparticle, and wherein the amino acid is selected from the group consisting of all naturally-occurring and synthetic amino acids, and wherein the molecular tether may be of any length.

17. The method according to claim 16 wherein the molecular tether is selected from the group consisting of methylenes, alkenyls, aryls, alkynyls, ethers, esters, amides and ketones.

18. The method according to claim 1 wherein said at least one type of moiety includes chiral molecular “hosts” on some of the nanoparticles and chiral molecular “guests” on other nanoparticles selected to bind to said chiral molecular hosts thereby forming a sensor comprising aggregates of nanoparticles linked together by “host-guest” interactions, and wherein exposing said aggregates to said chiral analyte in step b) said first member of the enantiomer pair competes effectively with the “guest” for the “host,” while the second member of the enantiomer pair does not, and wherein a diastereoselective dispersion of the aggregate occurs which responsively causes a discernable shift in the plasmon resonance band of the nanoparticles, from a long wavelength for the aggregated nanoparticles to a shorter wavelength for the dispersed particles.

19. The method according to claim 18 wherein said chiral molecular “host” is selected from the group consisting of binaphthyl-based compounds, cyclodextrins, calixarenes, cavitands, cryptophanes and hemicryptophanes and helicines.

20. The method according to claim 18 wherein the said chiral molecular ‘host’ is tethered to its associated nanoparticle by a molecular tether and wherein the molecular tether may be of any length.

21. The method according to claim 20 wherein said molecular tether is selected from the group consisting of methylenes, alkenyls, aryls, alkynyls, ethers, esters, amides and ketones.

22. The method according to claim 18 wherein said chiral molecular “host” includes two optically pure binaphthol groups linked together by a diethanolamine bridge that is tethered via nitrogen to its associated nanoparticle by way of a hexamethylene thiolate residue.

23. The method according to claim 18 wherein the molecular “guest” is a molecule possessing either hydrogen bond donor or hydrogen bond acceptor characteristics, or both, and wherein the molecular guest may or may not be chiral.

24. The method according to claim 18 wherein the molecular “guest” contains an amino acid residue that is tethered by a molecular tether to the nanoparticle, and wherein the amino acid is selected from the group consisting of all naturally-occurring and synthetic amino acids, and wherein the molecular tether may be of any length.

25. The method according to claim 24 wherein the molecular tether is selected from the group consisting of methylenes, alkenyls, aryls, alkynyls, ethers, esters, amides and ketones.

26. The method according to claim 1 wherein said at least one type of moiety includes a chiral molecular “host” comprising molecular guest molecules bound between chiral molecular hosts on some of the nanoparticles and a second type of moiety on other nanoparticles wherein said first type of chiral molecular ‘host” is selected to bind preferentially through “host-guest” interactions with said first member of the enantiomer pair over the second member, and said second type of moiety is selected to bind covalently and equally with both said first and second members of the enantiomer pair, and wherein upon exposing said nanoparticles to said chiral analyte in said step b) both members of the enantiomer pair bind to said second type of moiety, while only said first member of the enantiomer pair binds to said first type of chiral molecular host to form a diastereoselective aggregation of the dispersed particles, which responsively causes a discernable shift in the plasmon resonance band of the nanoparticles, wherein said plasmon resonance band of the nanoparticles is a strong, nanoparticle-based, absorption band in the visible region, from a short wavelength for the dispersed nanoparticles to a longer wavelength for the aggregated particles, and wherein in step c) includes detecting and quantifying said discernable shift wherein the extent of the discernable shift is indicative of the degree to which the nanoparticles are aggregated and provides a rapid and effective measure of the enantiomer excess (ee) of the chiral analyte.

27. The method according to claim 26 wherein said chiral molecular “host” is selected from the group consisting of binaphthyl-based compounds, cyclodextrins, calixarenes, cavitands, cryptophanes and hemicryptophanes and helicines.

28. The method according to claim 26 wherein the said chiral molecular “host” is tethered to its associated nanoparticle by a molecular tether and wherein the molecular tether may be of any length.

29. The method according to claim 28 wherein said molecular tether is selected from the group consisting of methylenes, alkenyls, aryls, alkynyls, ethers, esters, amides and ketones.

30. The method according to claim 26 wherein said chiral molecular “host” includes two optically pure binaphthol groups linked together by a diethanolamine bridge that is tethered via nitrogen to its associated nanoparticle by way of a hexamethylene thiolate residue.

31. The method according to claim 27 wherein the molecular “guest” is a molecule possessing either hydrogen bond donor or hydrogen bond acceptor characteristics, or both, and wherein the molecular guest may or may not be chiral.

32. The method according to claim 27 wherein said second type moiety is a molecular tether having a reactive solution-facing terminus, which terminus may be an organic functional group and wherein the tether may be of any length.

33. The method according to claim 32 wherein said organic functional group is selected from the group consisting of acid, acid chloride, amines, or azides, and wherein the tether may be of any length.

34. The method according to claim 32 wherein the tether is selected from the group consisting of methylenes, alkenyls, aryls, alkynyls, ethers, esters, amides and ketones.

35. The method according to claim 1 wherein said at least one type of moiety includes a chiral molecular “host” selected to bind with only one of said first and second members of the enantiomer pair and wherein upon exposing said nanoparticles to said chiral analyte in step b) said only one of said first and second members bind to the chiral molecular host on one nanoparticle and to another chiral molecular host on another nanoparticle to form a diastereoselective aggregation of the dispersed nanoparticles which responsively causes a discernable shift in the plasmon resonance band of the nanoparticles, wherein said plasmon resonance band of the nanoparticles is a strong, nanoparticle-based, absorption band in the visible region, from a short wavelength for the dispersed nanoparticles to a longer wavelength for the aggregated particles, and wherein in step c) includes detecting and quantifying said discernable shift wherein the extent of the discernable shift is indicative of the degree to which the nanoparticles are aggregated and provides a rapid and effective measure of the enantiomer excess (ee) of the chiral analyte.

36. The method according to claim 35 wherein said chiral molecular “host” is selected from the group consisting of binaphthyl-based compounds, cyclodextrins, calixarenes, cavitands, cryptophanes and hemicryptophanes and helicines.

37. The method according to claim 35 wherein the said chiral molecular “host” is tethered to its associated nanoparticle by a molecular tether and wherein the molecular tether may be of any length.

38. The method according to claim 37 wherein said molecular tether is selected from the group consisting of methylenes, alkenyls, aryls, alkynyls, ethers, esters, amides and ketones.

39. The method according to claim 35 wherein said chiral molecular “host” includes two optically pure binaphthol groups linked together by a diethanolamine bridge that is tethered via nitrogen to its associated nanoparticle by way of a hexamethylene thiolate residue.

40. The method according to claim 1 wherein said at least one type of moiety includes a chiral molecular “host” selected to bind preferentially through “host-guest” interactions with the first of the enantiomer pair, comprising a molecular tether selected to bind covalently and equally to both members of the enantiomer pair and wherein step b) includes exposing said molecular tethers and said nanoparticles to said chiral analyte whereupon both of said members of the enantiomer pair bind to the molecular tethers, and one enantiomer of a “di-guest” so formed binds the to chiral molecular “host” on one nanoparticle and to another chiral molecular “host” on another nanoparticle to form a diastereoselective aggregation of the dispersed nanoparticles which responsively causes a discernable shift in the plasmon resonance band of the nanoparticles, wherein said plasmon resonance band of the nanoparticles is a strong, nanoparticle-based, absorption band in the visible region, from a short wavelength for the dispersed nanoparticles to a longer wavelength for the aggregated particles, and wherein said and wherein in step c) includes detecting and quantifying said discernable shift wherein the extent of the discernable shift is indicative of the degree to which the nanoparticles are aggregated and provides a rapid and effective measure of the enantiomer excess (ee) of the chiral analyte.

41. The method according to claim 40 wherein said chiral molecular “host” is selected from the group consisting of binaphthyl-based compounds, cyclodextrins, calixarenes, cavitands, cryptophanes and hemicryptophanes and helicines.

42. The method according to claim 40 wherein said chiral molecular “host” is tethered to its associated nanoparticle by a molecular tether and wherein the molecular tether may be of any length.

43. The method according to claim 42 wherein said molecular tether is selected from the group consisting of methylenes, alkenyls, aryls, alkynyls, ethers, esters, amides and ketones.

44. The method according to claim 40 wherein said chiral molecular “host” includes two optically pure binaphthol groups linked together by a diethanolamine bridge that is tethered via nitrogen to its associated nanoparticle by way of a hexamethylene thiolate residue.

45. The method according to claim 1 wherein said nanoparticles are selected from the group consisting of any metallic nanoparticle of size ranging from about 1 to about 1000 nm.

46. The method according to claim 1 wherein said nanoparticles are gold nanoparticles of about 33 nm diameter.

47. The method according to claim 1 wherein said chiral analyte is a product of an asymmetric catalytic reaction, or any other chiral species capable of interacting with the chiral molecular “host.”

48. The method according to claim 1 wherein said chiral analyte is a product of the amide bond-forming reaction between both alanine and 6-bromohexanoic acid.
